(19) United States
(12) Patent Application Publication
(10) Pub. No.: US 2008/0036401 A1
(43) Pub. Date: Feb. 14, 2008

(54) Dual Mode Lighting Device

(75) Inventor: Robert Erhardt, Schaumburg, IL (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,816

(22) PCT Filed: Sep. 15, 2005
(86) PCT No.: PCT/IB05/53036

§ 371 Date: Mar. 22, 2007

Related U.S. Application Data
(60) Provisional application No. 60/612,038, filed on Sep. 22, 2004.

(51) Int. Cl. H05B 37/02

(52) U.S. Cl. 315/349

(57) ABSTRACT

A dual mode lighting device including a processor (86), a bus monitor (90) operably connected to receive a received wired signal (96) and to provide a bus signal (100) to the processor (86), and an antenna (88) operably connected to receive a received wireless signal (92) and to provide an antenna signal (102) to the processor (86), wherein the received wired signal (96) and the received wireless signal (92) conform to compatible communications protocols.

This invention relates generally to lighting systems, and more specifically to dual mode lighting devices using both wired and wireless communication.

Gas discharge lamps, such as fluorescent lamps, require a ballast to limit the current to the lamp. Electronic ballasts have become increasingly popular due to their many advantages. Electronic ballasts provide greater efficiency—as much as 15% to 20% over magnetic ballast systems. Electronic ballasts produce less heat, reducing building cooling loads, and operate more quietly, without “hum.” In addition, electronic ballasts offer more design and control flexibility.

One particular challenge is to provide effective, inexpensive control of a lighting system including multiple electronic ballasts and controls. One communications protocol for lighting systems is the Digital Addressable Lighting Interface (DALI) protocol set out in Annex E of the fluorescent ballast standard IEC 60929. The DALI protocol sets interface standards so that ballasts from different manufacturers are useable in a particular lighting system.

Existing hardware to implement the DALI protocol requires a pair of wires connecting controllers for each of the electronic ballasts and controls within the lighting system cell. The pair of wires acts as a communications bus, carrying instructions to and receiving responses from the individual controllers within the cell. At least one controller within the cell acts as a master controller, communicating with the lighting management system.

DALI instructions include an address byte and an instruction data byte. The address byte acts as a controller ID and determines the DALI controller for which the message is intended. Sixty-four unique addresses are available within the cell, plus sixteen group addresses. A particular controller can belong to more than one group at one time. Instructions can be made to individual addresses or group addresses and lighting scenes can be defined involving individual and/or group addresses. The DALI instruction data byte can be a command or a query. Examples of commands include directions to a controller to extinguish the lamp, to set the power level to a selected value, or to dim down at a selected rate. Examples of queries include requests of a controller of lamp or controller status, or requests for stored data, such as current, minimum, or maximum light level. The DALI response includes a response data byte, which provides the query results to the requesting controller.

Other communications protocols are also available. For example, the ZigBee protocol operating on top of the IEEE 802.15.4 wireless standard provides a cost-effective, standards-based wireless network that supports low data rates, low power consumption, security, and reliability. Additional wired and wireless protocols, both open and proprietary, are used in lighting system control.

Development efforts are underway to replace the wired system using a pair of wires to connect controllers with a wireless architecture. The controllers within a cell communicate with radio frequency (RF) signals. Although the freedom from wires provides the potential of reduced installation costs and increased design flexibility, a wireless system is not suitable for all situations. Obstructions or radio frequency emitting devices can interfere with the RF signals. In some situations, a wired system may be preferable to a wireless system.

One problem with the existing wired systems and the new wireless systems is that both are “all or nothing,” i.e., each cell is either all wired or all wireless. The systems only operate in a single mode: the wired mode or the wireless mode. All the controllers within a cell must be wired or wireless, although one or the other may be more suitable for certain locations within the cell. As such, a system designer is forced to use wireless controllers on part of a wireless lighting system where installation is easy and wired controllers would be less expensive. Conversely, a system designer is forced to use wired controllers on part of a wired lighting system where installation is difficult and wireless controllers would be easy to install. In addition, should the user wish to convert a cell from wired to wireless or vice versa, the user is forced to convert the whole cell from one technology to the other at once, rather than replacing a few controllers at a time and phasing in the changeover. This presents a cash flow problem and makes it less likely that the user will convert to the more beneficial system.

It would be desirable to have a dual mode lighting controller that overcomes the above disadvantages.

One aspect of the present invention provides a dual mode lighting device processor, a bus monitor operably connected to receive a received wired signal and to provide a bus signal to the processor, and an antenna operably connected to receive a received wireless signal and to provide an antenna signal to the processor, wherein the received wired signal and the received wireless signal conform to compatible communications protocols.

Another aspect of the present invention provides a method of dual mode lighting control including providing a lighting device operable to communicate in a first mode and a second mode, receiving a received signal at the lighting device in the first mode, and transmitting a transmitted signal from the lighting device in a mode selected from the first mode and the second mode.

Another aspect of the present invention provides a system of dual mode lighting control including means for receiving a received signal in a first mode, means for processing the received signal to generate a transmitted signal, and means for transmitting the transmitted signal in a mode selected from the first mode and the second mode.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

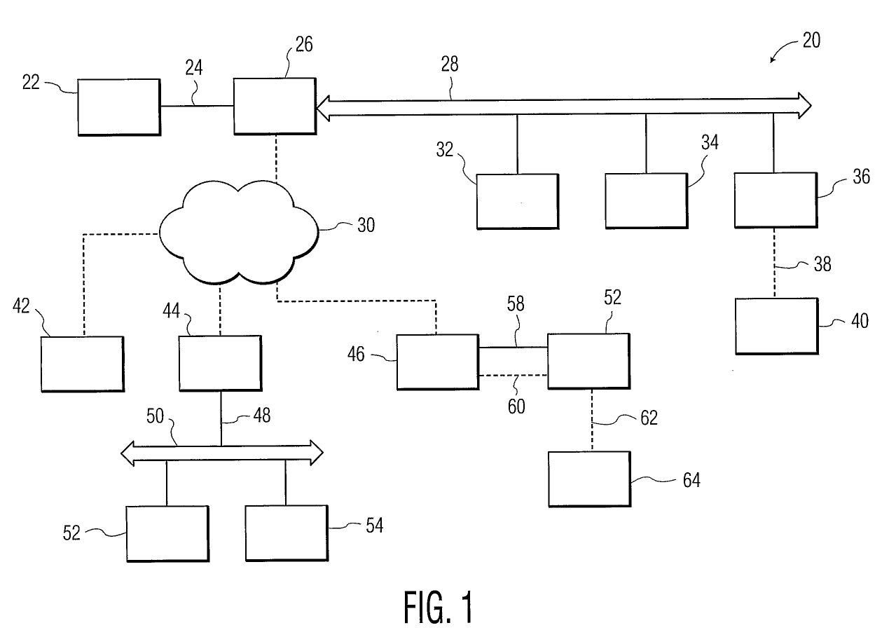

FIG. 1 is a block diagram of a lighting system including dual mode lighting devices made in accordance with the present invention; and

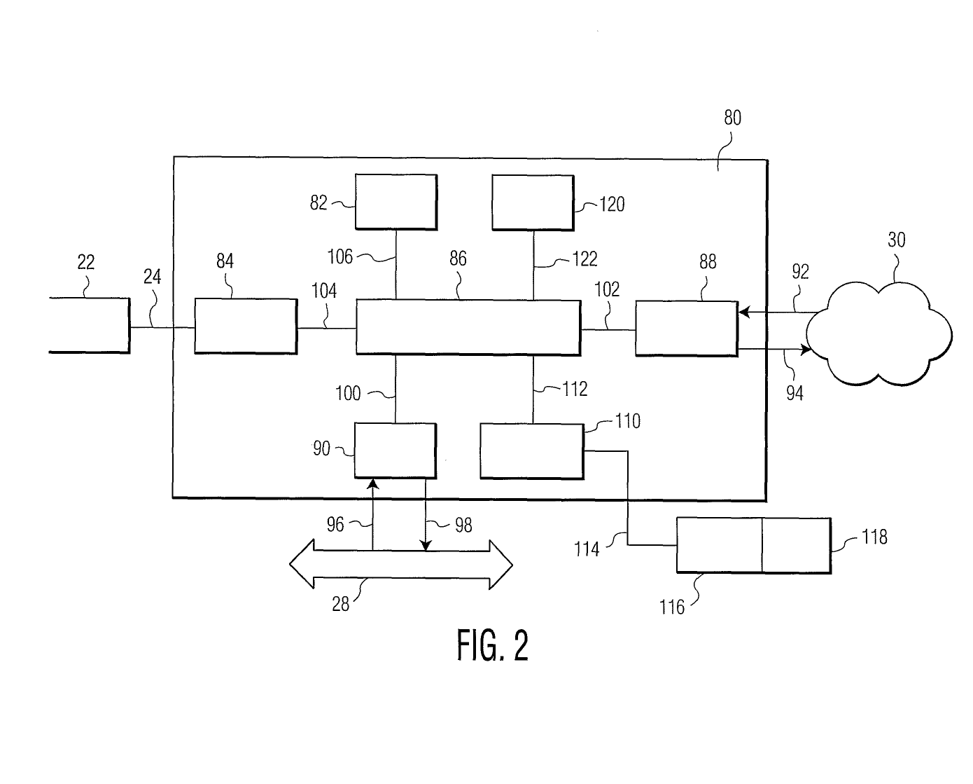

FIG. 2 is a block diagram of a dual mode lighting device made in accordance with the present invention.

FIG. 1 is a block diagram of a lighting system including dual mode lighting devices made in accordance with the present invention. The lighting system 20 includes a system control 22 providing a system signal 24 to a master device 26, which controls slave devices and is connected to independent lighting control devices. The slave devices can be individual lamp ballasts or other lighting controls. The independent lighting control devices can be occupancy detectors, wall controls, scene controls, remote controls, light sensors, or the like. In one embodiment, the devices are dual mode lighting devices. In an alternative embodiment, the devices are a mixture of dual mode lighting devices and conventional devices.

The system control 22 is a computer running lighting management software or another control device providing control for one or a number of lighting system cells. The system control 22 can control multiple buildings, floors within a building, zones within a floor, or desired combinations thereof. In an alternative embodiment, the system control 22 is a sensor supplying information to one or more groups of devices on light level, occupancy, or user input. The system control 22 can be connected to and operate a number of master devices. In the example shown, the system control 22 controls a single lighting system cell through the master device 26. The system control 22 communicates with the master device 26 through the system signal 24, sending instructions and queries to the master device 26 and receiving responses from the master device 26. The connection between the system control 22 and the master device 26 can be wired or wireless, such as an 802.11 wireless or Ethernet connection implementing TCP/IP, or through a wired bus or the airwaves implementing compatible communications protocols such as DALI or ZigBee protocols.

FIG. 1 provides examples of possible combinations of the slave devices within the lighting system cell. The master device 26 receives system signals 24 from the system control 22 and communicates with the slave devices within the lighting system cell. The master device 26 is operably connected to send and receive wired signals on a wired bus 28 and to send and receive wireless signals on airways 30. In one embodiment, the wired signals and/or wireless signals follow the same communications protocol, such as the Digital Addressable Lighting Interface (DALI) protocol set out in Annex E of the fluorescent ballast standard IEC 60929. When the wired signals follow the DALI protocol, the wired bus 28 is a wire pair. The wireless signals can be transmitted over the airways 30 in a number of frequencies, such as 2.4 GHz, or the like. The master device 26 communicates with slave devices 32, 34, 36 in a first mode (wired mode) and communicates with slave devices 42, 44, 46 in a second mode (wireless mode). In an alternate embodiment, the wired signals and/or wireless signals follow a wireless communications protocol such as the ZigBee protocol operating on top of the IEEE 802.15.4 wireless standard. In another alternate embodiment, the wired signals and/or wireless signals follow compatible communications protocols. Compatible communications protocols are defined as communications protocols that are able to convey the same or equivalent information in the same or similar time frames. Compatible communications protocols can be the same or different communications protocols.

The slave devices 32, 34, 36 are connected to the wired bus 28 to receive wired signals from and send wired signals to the master device 24. In one embodiment, the slave devices 32, 34 are conventional wired slave devices. In an alternative embodiment, the slave devices 32, 34 are dual mode slave devices. The slave device 36 is a dual mode slave device. In the example shown, the slave device 36 communicates with a slave device 40 with a wireless signal 38. The slave device 36 communicates with the master device 26 in a first mode (wired mode) and communicates with the slave device 40 in a second mode (wireless mode).

The slave devices 42, 44, 46 communicate with the master device 26 using wireless signals over the airways 30. In one embodiment, the slave device 42 is a conventional wireless slave device. In an alternative embodiment, the slave device 42 is a dual mode slave device.

The slave device 44 communicates with slave devices 52, 54 with a wired signal 48 over wired bus 50. The slave device 44 communicates with the master device 26 in a first mode (wireless mode) and communicates with the slave devices 52, 54 in a second mode (wired mode). In one embodiment, the slave devices 52, 54 are conventional wired slave devices. In an alternative embodiment, the slave devices 52, 54 are dual mode slave devices.

The slave device 46 communicates with the master device 26 over the airways 30 in a wireless mode and communicates with slave device 56 with either a wired signal 58 or a wireless signal 60. In one embodiment, the slave device 46 determines whether to communicate with slave device 56 using the wired signal 58 or the wireless signal 60. In an alternative embodiment, the slave device 46 attempts to communicate with both the wired signal 58 and the wireless signal 60, and the slave device 56 determines which of the signals to use. Those skilled in the art will appreciate that the slave device 46 can be in communication with the master device 26 over a wired bus, rather than the airways. The slave device 56 communicates with a slave device 64 with a wireless signal 62.

The master or slave lighting devices, such as master device 26, or slave devices 32, 42, can be independent lighting control devices, instead of or as well as lamp ballast controllers. As an independent lighting control device, the lighting device includes a local input as a sensor, such as a light sensor or occupancy detector, or a local control, such as a wall control, remote control, or scene control.

In one example, the lighting system can maintain the illumination level in an area by adjusting the artificial light level from the lighting system lamps as the natural light coming into the area changes. The lamp illumination level for the lamps in a lighting system cell is set, by a command from the master controller or from another device. A lighting device within the lighting system cell includes a lighting sensor as a local input measuring light intensity at the lighting device. The lighting device receives a desired light intensity setting corresponding to the lamp illumination level from the master controller and stores the desired light setting. The measured light level from the lighting sensor is compared to the desired light intensity setting at desired time intervals. When there is a difference between the measured light level and the desired light setting, the processor calculates a level correction signal. The level correction signal is sent as a command to each of the lamp controllers in the lighting system cell, adjusting the lamp illumination level of each lamp to maintain the desired light level in the area.

Those skilled in the art will appreciate that numerous combinations of dual mode lighting devices, conventional wired devices, and conventional wireless devices are possible to meet any desired configuration. Dual mode lighting devices and conventional wired devices can be used where wireless devices encounter interference. Dual mode lighting devices and devices and conventional wireless devices can be used where installation of a wired bus is impractical. Dual mode lighting devices, conventional wired devices and devices, and conventional wireless devices can be used as an intermediate configuration when changing from a wired lighting system to a wireless lighting system, or vice versa.

FIG. 2 is a block diagram of a dual mode lighting device made in accordance with the present invention. The dual mode lighting device 80 communicates with other devices over wired bus 28 and/or airways 30. The dual mode lighting device 80 can be a master controller, a slave controller, or an independent lighting control device such as an occupancy detector, wall control, remote control, scene control, light sensor, or the like. In the example shown, the dual mode lighting device 80 is a master device, connected to system control 22.

The dual mode lighting device 80 includes memory 82, processor 86, antenna 88, bus monitor 90, and ballast interface 110. The memory 82 is operably connected to the processor 86 through memory signal 106 to store data and instructions for operation of the processor 86. The processor 86 controls operation of the dual mode lighting device 80, including communications through the antenna 88 and the bus monitor 90. The processor 86 can be one processor or a number of processors. The antenna 88 receives received wireless signal 92 from and transmits transmitted wireless signal 94 to other devices within the lighting system cell through the airways 30. The antenna 88 communicates with the processor 86 with an antenna signal 102. The bus monitor 90 receives received wired signal 96 from and transmits transmitted wired signal 98 to other devices within the lighting system cell through the wired bus 28. The bus monitor 90 communicates with the processor 86 with a bus signal 100. The received wireless signal 92 and received wired signal 96 are received signals and the transmitted wireless signal 94 and transmitted wired signal 98 are transmitted signals.

In one embodiment, the dual mode lighting device 80 is a controller which is part of ballast and ballast interface 110 can be located within the dual mode lighting device 80. The ballast interface 110 communicates by ballast signal 112 with the processor 86 and communicates by lamp control signal 114 with ballast 116 controlling lamp 118. In an alternative embodiment, the dual mode lighting device 80 is an independent control device and the ballast interface 110 can be separate from the dual mode lighting device 80. The ballast interface 110 communicates by ballast signal 112 with the processor 86 over a wired bus 28 or the airwaves.

The master device within the lighting system cell provides the instructions and detects the responses. In one embodiment, the dual mode lighting device 80 is a master device and the processor 86 communicates with the system control 22 with an interface signal 104 through a system interface 84. The system control 22 can be connected to one or more master devices to control lighting throughout a zone or building. Those skilled in the art will appreciate that the system interface 84 can be internal or external to the dual mode lighting device 80 depending on the particular configuration desired.

The dual mode lighting device 80 operates in different manners depending on the desired application. The dual mode lighting device 80 can operate as a master or a slave device. As a slave device, the dual mode lighting device 80 can be passive and only respond to a signal including its device ID, or can be a repeater and re-transmit any signal received. In various embodiments, the dual mode lighting device 80 can receive a wired signal or a wireless signal, and can transmit a wired signal, a wireless signal, or both a wired signal and a wireless signal. The manner of operation can be preset before the dual mode lighting device 80 is installed, or can be set by command from the system control 22, programming through the wired bus 28, or programming over the airwaves 30.

When the dual mode lighting device 80 is a master device, the dual mode lighting device 80 controls operation of the lighting system cell, which can include various combinations of lamps, ballasts, and other slave devices. The master device can also have an associated ballast 116 and lamp 118, and/or an associated control input 120 providing a control input signal 122 to the processor 86. The master device communicates with the system control 22 with a system signal 24 through a system interface 84. The system control 22 can be connected to the master device by a wired or wireless connection, such as an 802.11 wireless or Ethernet connection implementing TCP/IP, or through a wired bus or the airwaves implementing compatible communications protocols such as DALI or ZigBee protocols. The system signal 24 can be an instruction or query to the master device from the system control 22, or a response from the master device to the system control 22. The system interface 84 receives, sends, and/or translates between the system signal 24 and the interface signal 104 as required. When the interface signal 104 is an instruction or query to the lighting system cell, the processor 86 formats the instruction or query to the communications protocol understood by the slave devices, such as the DALI protocol. Through memory signal 106, the memory 82 can provide data or instructions to the processor 86, or store data or instructions from the processor 86.

As a master device, the dual mode lighting device 80 can operate in the wired, wireless, or combined wired/wireless modes. In the wired mode, the processor 86 communicates with the bus monitor 90 with the bus signal 100. The bus monitor 90 transmits transmitted wired signal 98 to and receives received wired signal 96 from slave devices within the lighting system cell through the wired bus 28. In the wireless mode, the processor 86 communicates with the antenna 88 with the antenna signal 102. The antenna 88 transmits transmitted wireless signal 94 to and receives received wireless signal 92 from slave devices within the lighting system cell through the airways 30. In the combined wired/wireless mode, the processor 86 communicates with slave devices through both the antenna 88 and the bus monitor 90.

The master device can control an associated ballast and lamp as desired. A ballast interface 110 communicates by ballast signal 112 with the processor 86 of the dual mode lighting device 80, which has a device ID stored in the memory 82. The ballast interface 110 communicates with ballast 116 to control lamp 118 when receiving an instruction or query addressed to the stored device ID of the dual mode lighting device 80. In one embodiment, the dual mode lighting device 80 is enclosed in the same housing and part of the ballast 116. In an alternative embodiment, the dual mode lighting device 80 is enclosed in a different housing and is separate from the ballast 116. In another alternative embodiment, the ballast interface 110 can be omitted and the dual mode lighting device 80 acts as a master device with no associated ballast and lamp.

The master device can include control input 120 providing a control input signal 122 to the processor 86 as desired. The control input 120 can be a sensor, such as a light sensor or occupancy detector, or a local control, such as a wall control, remote control, or scene control. The master device can adapt its operation in response to the control input signal 122, provide the information in the control input signal 122 to other lighting devices, and/or provide transmitted signals to other lighting devices incorporating commands to those lighting devices based on the control input signal 122.

When the dual mode lighting device 80 is a slave controller, the dual mode lighting device 80 controls operation of an associated ballast 116 and lamp 118, translates between a first mode and a second mode, repeats a wireless signal, and/or acts as an independent lighting control device. The slave device communicates with the master device for its lighting system cell over the airways 30 or the wired bus 28. The slave device can communicates with the master device directly, or indirectly with signals relayed through other slave devices. No system interface 84 is required for the slave device, although the system interface 84 can be retained to allow interchangeability of devices.

As a ballast device, the slave device can operate in a wired or wireless mode.

In the wired mode, the slave device receives a received wired signal 96 from the wired bus 28 at the bus monitor 90, which passes the information in the received wired signal 96 to the processor 86 through the bus signal 100. The processor 86 determines when the bus signal 100 applies to the particular slave device by checking the device ID in the bus signal 100 with the device ID for the particular slave device stored in the memory 82. When the device IDs match and the bus signal 100 applies to the particular slave device, the processor 86 sends a ballast signal 112 to the ballast interface 110 to control the lamp 118 through the ballast 116. The particular slave device can also respond to a query from the master device, sending the information requested from the processor 86 to the bus monitor 90, which sends the information to the wired bus 28 with the transmitted wired signal 98. The received wired signal 96 is a received signal and the transmitted wired signal 98 is a transmitted signal.

Operation in the wireless mode is similar to the operation in the wired mode. The slave device receives a received wireless signal 92 from the airways 30 at the antenna 88, which passes the information in the received wireless signal 92 to the processor 86 through the antenna signal 102. The processor 86 determines when the antenna signal 102 applies to the particular slave device by checking the device ID in the antenna signal 102 with the device ID for the particular slave device stored in the memory 82. When the device IDs match and the antenna signal 102 applies to the particular slave device, the processor 86 sends a ballast signal 112 to the ballast interface 110 to control the lamp 118 through the ballast 116. The particular slave device can also respond to a query from the master device, sending the information requested from the processor 86 to the antenna 88, which sends the information to the airways 30 with the transmitted wireless signal 94. The received wireless signal 92 is a received signal and the transmitted wireless signal 94 is a transmitted signal.

In one embodiment, the slave device can transmit both the transmitted wired signal 98 and the transmitted wireless signal 94.

In an alternate embodiment, the slave device can receive both a received wired signal 96 from the wired bus 28 and a received wireless signal 92 from the airways 30, with both signals applying to the particular slave device receiving the signals. Both signals contain the device ID for the particular slave device for redundancy, uncertainty about which mode is best suited, or any other reason desired. The processor 86 determines which signal to process. In one embodiment, the processor 86 uses the predetermined mode specified by a previous command from the master device and stored in the memory 82, e.g., the processor 86 uses the wireless mode per a stored preference. In an alternative embodiment, when the signals are not simultaneous, the processor 86 uses the mode according to the order of signal receipt. For example, the processor 86 uses a wired mode when the first signal received is a received wired signal and the stored preference calls for using the mode of the first signal received.

As a translator, the slave device can translate between a first mode and a second mode. As a wireless-to-wired translator, the slave device 80 receives a received wireless signal 92 from the airways 30 at the antenna 88 and provides the antenna signal 102 to the processor 86. The processor 86 provides the information from the antenna signal 102 to the bus monitor 90, which sends the information to the wired bus 28 on the transmitted wired signal 98. The wired bus 28 distributes the information to other devices connected to the wired bus 28. As a wired-to-wireless translator, the slave device 80 receives a received wired signal 96 from the wired bus 28 at the bus monitor 90 and provides the bus signal 100 to the processor 86. The processor 86 provides the information from the bus signal 100 to the antenna 88, which sends the information to the airways 30 on the transmitted wireless signal 94. The airways 30 distribute the information to other devices within range of the antenna 88.

In an alternative embodiment, the slave device 80 can translate between one compatible communications protocol and another. In one example, the slave device 80 receives a received wireless signal 92 in a first compatible communications protocol, such as the DALI protocol, from the airways 30 at the antenna 88 and provides the antenna signal 102 to the processor 86. The processor 86 converts the antenna signal 102 to a second compatible communications protocol, such as the ZigBee protocol. The processor 86 sends the information in the ZigBee protocol through the antenna 88 to the airways 30 as the transmitted wireless signal 94. Those skilled in the art will appreciate that a number of combinations are possible. The slave device 80 can translate wired to wireless and/or one compatible communications protocol and another.

As a repeater, the slave device can receive a signal in a mode and transmit the signal in the same mode. This is particularly useful when the received signal is weak, such as when a wireless signal is at the end of its range or obstructed. In the wired mode, the slave device 80 receives a received wired signal 96 from the wired bus 28 at the bus monitor 90 and provides the bus signal 100 to the processor 86. The processor 86 resends the information from the bus signal 100 through the bus monitor 90 to the wired bus 28 as the transmitted wired signal 98. The bus monitor 90 can provide amplification to achieve the signal level desired. In the wireless mode, the slave device 80 receives a received wireless signal 92 from the airways 30 at the antenna 88 and provides the antenna signal 102 to the processor 86. The processor 86 resends the information from the antenna signal 102 through the antenna 88 to the airways 30 as the transmitted wireless signal 94. The antenna 88 can provide amplification to achieve the signal level desired.

As an independent lighting control device, the slave device can receive local input at the slave device and use the input or provide the information in the control input to other lighting devices. The slave device can include a control input 120 providing a control input signal 122 to the processor 86. The control input 120 can be a sensor, such as a light sensor or occupancy detector, or a local control, such as a wall control, remote control, or scene control. The slave device can adapt its operation in response to the control input signal 122, provide the information in the control input signal 122 to other lighting devices, and/or provide transmitted signals to other lighting devices incorporating commands to those lighting devices based on the control input signal 122.

While the embodiments of the invention disclosed herein are presently considered to be preferred, various changes and modifications can be made without departing from the scope of the invention. The scope of the invention is indicated in the appended claims, and all changes that come within the meaning and range of equivalents are intended to be embraced therein.

1. A dual mode lighting device, the device comprising:
a processor 86;
a bus monitor 90, the bus monitor 90 operably connected to receive a received wired signal 96 and to provide a bus signal 100 to the processor 86; and
an antenna 88, the antenna 88 operably connected to receive a received wireless signal 92 and to provide an antenna signal 102 to the processor 86;
wherein the received wired signal 96 and the received wireless signal 92 conform to compatible communications protocols.

2. The device of claim 1 wherein the compatible communications protocols are selected from the group consisting of a Digital Addressable Lighting Interface (DALI) protocol and a ZigBee protocol.

3. The device of claim 1 wherein the dual mode lighting device has a device ID, and the processor 86 monitors the bus signal 100 and the antenna signal 102 for the device ID.

4. The device of claim 3 further comprising a ballast interface 110, wherein the processor 86 directs the ballast interface 110 to generate a lamp control signal 114 when one of the bus signal 100 and the antenna signal 102 includes the device ID.

5. The device of claim 1 wherein the processor 86 directs the bus monitor 90 to transmit a transmitted wired signal 98 when the antenna 88 receives a received wireless signal 92.

6. The device of claim 1 wherein the processor 86 directs the antenna 88 to transmit a transmitted wireless signal 94 when the bus monitor 90 receives a received wired signal 96.

7. The device of claim 1 wherein the processor 86 directs the bus monitor 90 to transmit a transmitted wired signal 98 when the bus monitor 90 receives a received wired signal 96.

8. The device of claim 1 wherein the processor 86 directs the antenna 88 to transmit a transmitted wireless signal 94 when the antenna 88 receives a received wireless signal 92.

9. The device of claim 1 further comprising a ballast interface 110, the ballast interface 110 operably connected to receive a ballast signal 112 from the processor 86 and to provide a lamp control signal 114.

10. The device of claim 1 further comprising an system interface 84, the system interface 84 operably connected to receive a system signal 24 and to provide an interface signal 104 to the processor 86.

11. The device of claim 10 wherein the system signal 24 is selected from the group consisting of a wired signal, a wireless signal, an 802.11 signal, an Ethernet signal, a TCP/IP signal, a DALI protocol signal, and a ZigBee protocol signal.

12. The device of claim 1 further comprising memory 82 operably connected to the processor 86.

13. The device of claim 1 further comprising a control input 120 providing a control input signal 122 to the processor 86.

14. The device of claim 13 wherein the control input 120 is selected from the group consisting of sensors, light sensors, occupancy detectors, local controls, wall controls, remote controls, and scene controls.

15. A method of dual mode lighting control, the method comprising:
providing a lighting device operable to communicate in a first mode and a second mode;
receiving a received signal at the lighting device in the first mode; and
transmitting a transmitted signal from the lighting device in a mode selected from the first mode and the second mode.

16. The method of claim 15 wherein the first mode is a wired mode and the second mode is a wireless mode.

17. The method of claim 15 wherein the first mode is a wireless mode and the second mode is a wired mode.

18. The method of claim 15 further comprising receiving a second received signal at the lighting device in the second mode simultaneously with the receiving a received signal at the lighting device in the first mode, wherein the transmitting a transmitted signal comprises transmitting the transmitted signal in a predetermined mode selected from the first mode and the second mode.

19. The method of claim 15 wherein the transmitting a transmitted signal from the lighting device in a mode selected from the first mode and the second mode comprises transmitting a first transmitted signal from the lighting device in the first mode and transmitting a second transmitted signal from the lighting device in the second mode.

20. The method of claim 15 wherein the received signal conforms to a first compatible communications protocol and the transmitted signal conforms to a second compatible communications protocol.

21. The method of claim 15 further comprising generating a lamp control signal in response to the received signal.

22. The method of claim 15 further comprising:
setting at least one lamp illumination level;
measuring a light intensity at the lighting device;
comparing the light intensity to a desired light intensity setting to generate a level correction signal; and
adjusting the lamp illumination level by the level correction signal.

23. A system of dual mode lighting control, the system comprising:
means for receiving a received signal in a first mode;
means for processing the received signal to generate a transmitted signal; and
means for transmitting the transmitted signal in a mode selected from the first mode and a second mode.

24. The system of claim 23 further comprising means for receiving a second received signal in the second mode, wherein the means for transmitting the transmitted signal comprises means for transmitting the transmitted signal in a predetermined mode selected from the first mode and the second mode.

25. The system of claim 23 wherein the means for transmitting a transmitted signal from the lighting device in a mode selected from the first mode and the second mode comprises means for transmitting a first transmitted signal from the lighting device in the first mode and means for transmitting a second transmitted signal from the lighting device in the second mode.

26. The system of claim 23 wherein the received signal conforms to a first compatible communications protocol and the transmitted signal conforms to a second compatible communications protocol.

27. The system of claim 23 further comprising means for generating a lamp control signal in response to the received signal.

28. The system of claim 23 further comprising:
means for setting at least one lamp illumination level;
means for measuring a light intensity at the lighting device;
means for comparing the light intensity to a desired light intensity setting to generate a level correction signal; and
means for adjusting the lamp illumination level by the level correction signal.
